(19) United States
(12) Patent Application Publication
(10) Pub. No.: US 2016/0322182 A1
(43) Pub. Date: Nov. 3, 2016

(54) SWITCH STRUCTURE

(71) Applicant: proeasy network solutions co., LTD., Hsinchu County (TW)

(72) Inventor: Hsing-Hung Lu, Hsinchu County (TW)

(21) Appl. No.: 14/794,818

(22) Filed: Jul. 9, 2015

(30) Foreign Application Priority Data
Apr. 28, 2015 (TW) 104113514

(51) Int. Cl. H01H 21/18

(52) U.S. Cl. CPC H01H 21/18; H01H 2239/02

(57) ABSTRACT

A switch structure used for switching on or shut off an electronic system including a main body, a switching member pivoted thereto, a first electrical conducting portion electrically connected to the electronic system, a second electrical conducting portion movably disposed between the switching member and the first electrical conducting portion and electrically connected to the electronic system, and a force coupling assembly is provided. The second electrical conducting portion is located on a pivoting path of the switching member. The first electrical conducting portion is located on a moving path of the second electrical conducting portion. The switching member is located on a range of motion of the force coupling assembly. The force coupling assembly drives the switching member to rotate the switching relative to the main body, such that the switching member drives the second electrical conducting portion to leans against or release from the first electrical conducting portion.

### CROSS-REFERENCE TO RELATED APPLICATION

This application claims the priority benefit of Taiwan application serial no. 104113514, filed on Apr. 28, 2015. The entirety of the above-mentioned patent application is hereby incorporated by reference herein and made a part of this specification.

### BACKGROUND OF THE INVENTION

1. Field of the Invention

The invention relates to a switch structure.

2. Description of Related Art

The invention of electricity has brought a complete lifestyle change to humankind, contributing to significant developments and advancements in industry and technology and bringing applications of various kinds of electronic circuits and information systems into our life. However, the climate anomalies which came along with the development in technology have gradually increased the environmental awareness of people. In response, various methods for improvement have been proposed in the types energy sources and the efficiency thereof. However, regardless of any new energy source, in order to truly play an effect in carbon reduction. the principles of conservation need to be applied.

Aside from using electrical equipment with low energy consumption, the most important thing is to shut off the power of electrical equipment that is not in use to reduce the waste of unnecessary energy. In other words, not only can waste in electricity be effectively prevented by a means of good electricity management, safety in electricity usage is also provided. Therefore, for the various types of current electronic systems, in addition to proximal control, it is necessary to develop a means for performing remote control in order to increase the effectiveness in electricity management and at the same time achieving results in areas such as intelligent lifestyle and carbon reduction.

### SUMMARY OF THE INVENTION

The invention provides a switch structure to automatically or manually switch on and shut off an electronic system.

The invention provides a switch structure, used for switching on or shutting off an electronic system. The switch structure includes a main body, a switching member, a first electrical conduction part, a second electrical conduction part and a force coupling assembly. The switching member is pivoted at the main body. The first electrical conduction portion is disposed in the main body and electrically connected to the electronic system. The second electrical conduction portion is movably disposed between the switching member and the first electrical conduction portion and the second electrical conduction portion is located on a pivoting path of the switching member. The first electrical conduction portion is located on a moving path of the second electrical conduction portion. The force coupling assembly is disposed at the main body and the switching member is located within a range of motion of the force coupling assembly. The force coupling assembly abuts the switching member at different working times so as to drive the switching member to pivot relative to the main body such that the switching member drives the second electrical conduction portion to lean against the first electrical conduction portion or to release from the first electrical conduction portion. The electronic system is switched on or shut off when the first electrical conduction portion and the second electrical conduction portion abut together.

In an embodiment of the invention the force coupling assembly includes at least one power source and a pair of first driving components. The first driving components are disposed at two opposite sides of a pivoting point of the switching member and the main body respectively and connected with the power source. The power source drives the pair of first driving components to abut the switching member at different working times, to pivot the switching member in opposite directions.

In an embodiment of the invention, during another working time, the pair of first driving components are moved away and do not abut the switching member.

In an embodiment of the invention, the pair of first driving components are cams respectively, located under the switching member and rotate about a first axis, in which each of the cams push upward on the switching member with a protruding part.

In an embodiment of the invention, an orthographic projection of the pair of protruding parts of the pair of cams on a normal plane of the first axis have different directions.

In an embodiment of the invention, an angle between the different directions is 90 degrees.

In an embodiment of the invention, the at least one power source is a motor, in which the pair of cams are assembled on a same shaft of the motor.

In an embodiment of the invention, the at least one power source is a pair of motors, in which the pair of cams are assembled on a pair of shafts of the motors respectively.

In an embodiment of the invention, the force coupling assembly includes a lever disposed in the main body and located next to the switching member. The lever rotates about a second axis and the second axis does not pass through the switching member. The pair of first driving components are sliding blocks respectively disposed at two opposite sides of the lever. The power source is connected with and drives the lever to rotate, such that the pair of sliding blocks are driven to abut the two opposite sides of the switching member respectively.

In an embodiment of the invention, the force coupling assembly includes a power source and at least one second driving component. The second driving component is connected with the power source and passes through two opposite sides of a pivoting point of the switching member and the main body. The power source drives the second driving component to abut different spots of the switching member at different working times, to pivot the switching member in opposite directions.

In an embodiment of the invention, the force coupling assembly includes a rotating ring, connected with the power source, disposed in the main body and located under the switching member. The rotating ring rotates about a third axis and the third axis passes through the switching member. The at least one second driving component is a protrusion disposed on a surface of the rotating ring facing the switching member. The power source drives the rotating ring to rotate such that two respective sides of a pivoting point of the switching member and the main body are located on a moving path of the protrusion.

In an embodiment of the invention, the force coupling assembly includes a pair of protrusions disposed on the surface of the rotating ring facing the switching member respectively. The pair of protrusions and the third axis are not on a same diameter of the rotating ring.

In an embodiment of the invention, the switch structure further comprises a control module electrically connected with the force coupling assembly. The control module is adapted to receive wireless signals to drive the force coupling assembly accordingly.

Based on the above, in the switch structure of the invention, aside from the switching member able to receive an external applied force to drive the switching, the force coupling assembly in the main body may be controlled remotely to drive the switching under conditions when proximal control of the switching member is not available such that the user may achieve a result of controlling the switching on or shutting off of the electronic system regardless of a proximal or remote control method.

The accompanying drawings are included to provide a further understanding of the invention, and are incorporated in and constitute a part of this specification. The drawings illustrate embodiments of the invention and, together with the description, serve to explain the principles of the invention.

### BRIEF DESCRIPTION OF THE DRAWINGS

FIG. 1 is a schematic view of a switch structure according to an embodiment of the invention.

FIG. 2 is a cross-sectional view of the switch structure of FIG. 1.

FIG. 3 is a schematic view of the connections of the related components in the switch structure of FIG. 2.

FIG. 4 is a schematic view of a force coupling assembly in the switch structure of FIG. 2.

FIG. 5 is a schematic view of a switch structure according to another embodiment of the invention.

FIG. 6 is a schematic view of a switch structure according to another embodiment of the invention.

FIG. 7 is a partial cross-sectional view of the switch structure of FIG. 6 along the line B-B′.

FIG. 8 is a schematic view of partial components of a force coupling assembly according to another embodiment of the invention.

FIG. 9 is a schematic view of an operation of the force coupling assembly of FIG. 8 and a switching member.

### DESCRIPTION OF THE EMBODIMENTS

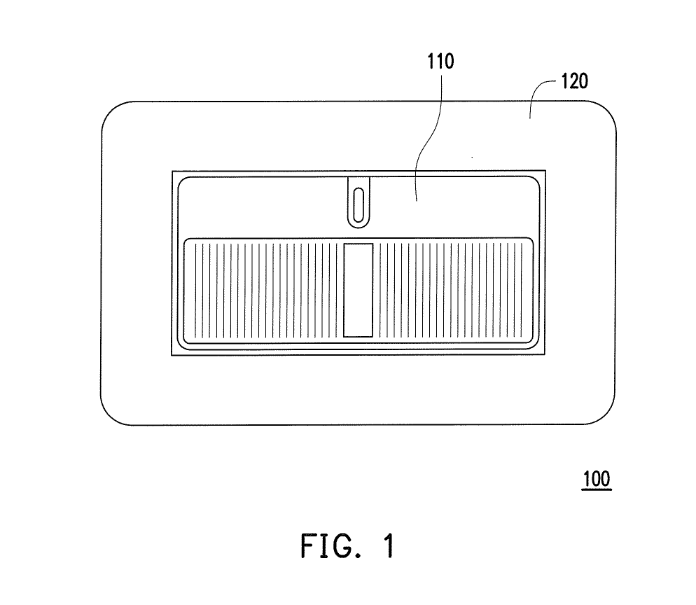

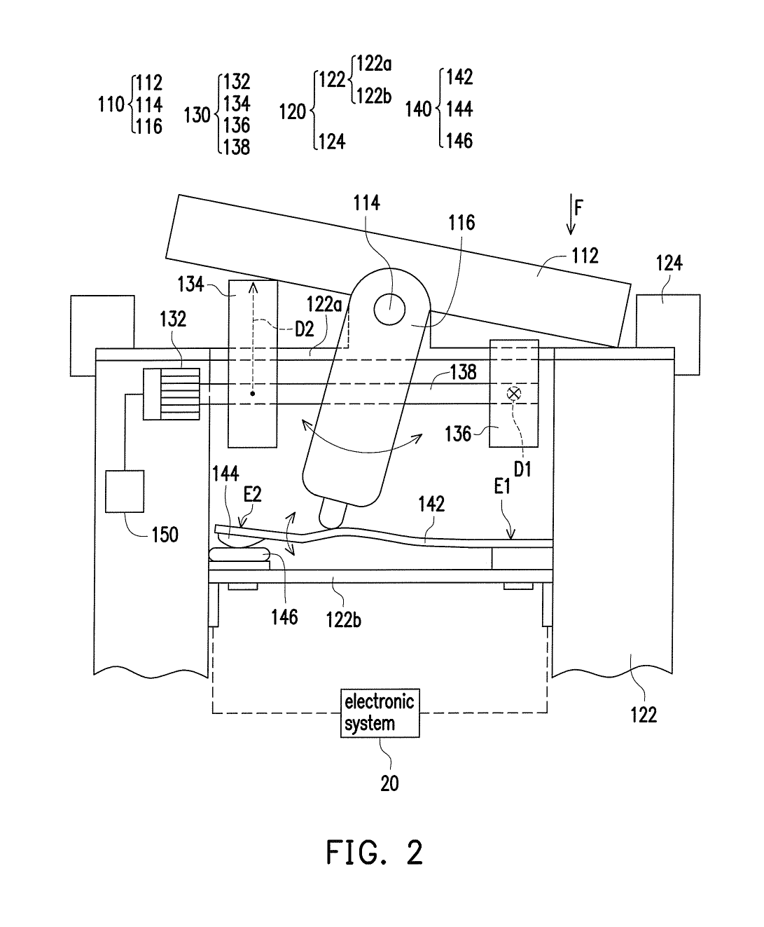

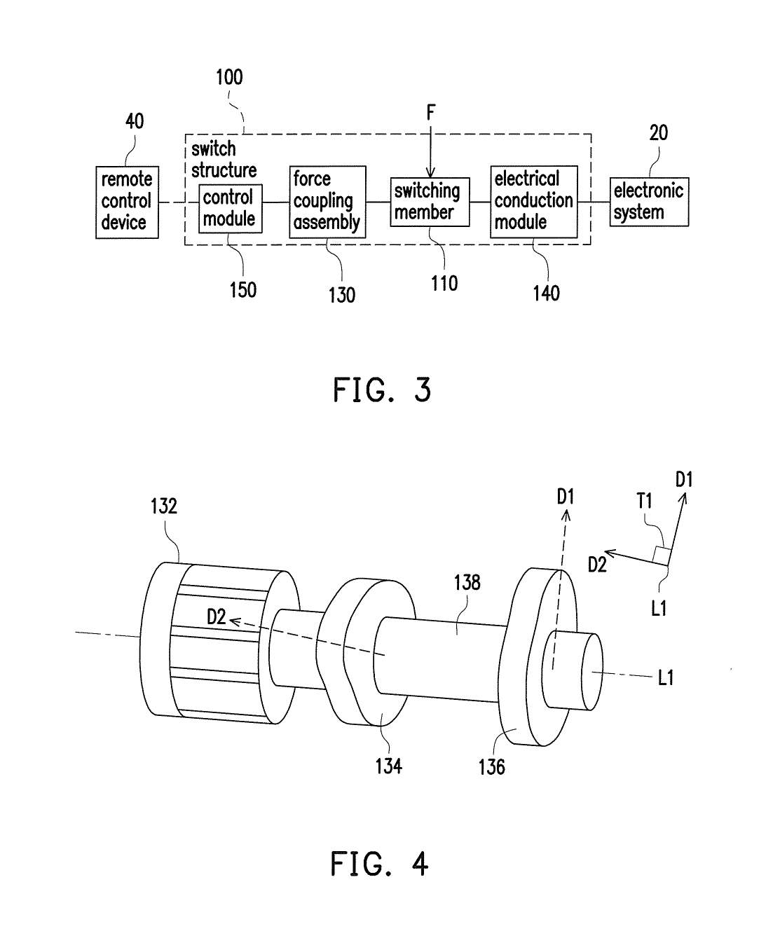

FIG. 1 is a schematic view of a switch structure according to an embodiment of the invention. FIG. 2 is a cross-sectional view of the switch structure of FIG. 1. FIG. 3 is a schematic view of the connections of the related components in the switch structure of FIG. 2. Referring to FIG. 1 to FIG. 3, in the present embodiment, a switch structure 100 is used for switching on or shutting off an electronic system 20. Here the electronic system 20 refers to various electronic devices or circuit systems in household appliances.

The switch structure 100 includes a main body 120, a switching member 110, an electrical conduction module 140, a control module 150 and a force coupling assembly 130. The main body 120 includes a frame 122 and a front cover 124 fitted in the walls, wherein the frame 122, for example, is constituted by a synthetic resin molded rectangular box with an opening at the front surface, the frame 122 is adapted to be fitted in the wall and used for housing other components. The front cover 124 is used to partially cover the opening at the front surface of the frame 122 and exposed at the wall surface. The switching member 110, for example, is a handle part of a rocker switch, and is pivoted at the top 122a of the frame 122 to be located rockabilly at a central opening of the front cover 124. That is to say, the switch structure 100 only has the switching member 110 exposed through a wall of the front cover 124 and the external appearance is similar to a conventional household switch structure. A user is able to directly exert an applied force F on the switching member 110 (applied force F may be applied to the left side and right side of the switching member 110 as shown in FIG. 2) to control the switch on and shut off operation of the switch structure 100 accordingly.

More specifically, the switching member 110 of the present embodiment is rendered in a “T” shape structure, and includes a pressing part 112, a abutting arm 116 and a pivoting part 114 connected between the pressing part 112 and the abutting arm 116. The pivoting part 114 is pivoted at the top 122a of the frame 122 and the pressing part 112 is located at the central opening of the front cover 124 to receive the applied force F, such that the switching member 110 swings in the main body 120 through the pivoting part 114 to achieve a switch effect. The electrical conduction module 140 which is disposed in the frame 122 of the main body 120 includes an electrical conduction portions 142 and 146. The electrical conduction portion 142, for example, is a spring (reed plate) structure, having two opposite ends E1, E2. The end E1 is fixed at the bottom 122b of the frame 122 and is electrically connected to the electronic system 20. The end E2 extends from the end E1 and forms a cantilever structure (when not abutted by the switching member 110, described later). Furthermore, the electrical conduction portion 146 is fixed at the bottom 122b of the frame 122 and is electrically connected to the electronic system 20; the electrical conduction portion 146 and the electrical conduction portion 142 correspond together at the contact 144 located at the end E2.

In other words, the end E2 of the electrical conduction portion 142 is located movably between the switching member 110 and the electrical conduction portion 146; the electrical conduction portion 142 is located on a pivoting path (swing path) of (the abutting arm 116 of) the switching member 110; and the electrical conduction portion 146 is located on the moving path of the contact 144 of the electrical conduction portion 142. In this way, when the user exerts an applied force F on the pressing part 112 of the switching member 110, the switching member 110 is driven to pivot relative to the main body 120, such that the abutting arm 116 abuts the end E2 of the electrical conduction portion 142 so the end E2 moves closer to the electrical conduction portion 146 due to elastic deformation, and making the contact 144 and the electrical conduction portion 146 abut together allowing the electronic system 20 to achieve an electrically conductive state to switch on or shut off the electronic system 20.

It should be noted, the force coupling assembly 130 is disposed in the fame 122 of the main body 120 and is electrically connected with the control module 150. In the present embodiment, the force coupling assembly 130 includes a power source 132 (for example a motor electrically connected with the control module 150) and a pair of driving components 134, 136. The control module 150 is adapted to receive a wireless signal of the remote control device 40 to activate the power source 132 accordingly. As shown in FIG. 2, the driving components 134, 136 are a pair of cams, disposed at two opposite sides of the pivoting point of the switching member 110 and the main body 120. The pressing part 112 is located within a range of motion of the driving components 134, 136 to drive the cams to rotate when the motor is turned on, and push on the switching member 110.

FIG. 4 is a schematic view of a force coupling assembly in the switch structure of FIG. 2. Referring to FIG. 2 and FIG. 4, more specifically, the driving components 134, 136 of the present embodiment are a pair of cams disposed on a same shaft 138, and are located below the pressing part 112 and rotate about the axis L1 when driven by the motor, such that the protruding parts push upwards onto the pressing part 112 during the process of the cams rotating. As shown in FIG. 4, orthographic projections of the protruding parts of the driving components 134, 136 on a normal plane of the axis L1 have different directions D1, D2, and the directions D1, D2 have an angular misalignment. In the present embodiment, there is a 90 degree angle between the directions D1, D2 (as shown at the direction schematic on the right side of FIG. 4, there is an angle T1 between the directions D1, D2). In this way, the force coupling assembly 130 is able to abut different parts of the switching member 110 at different working times, such that the switching member 110 pivots in opposite directions relative to the main body 120 respectively to achieve a switching effect.

As shown in FIG. 2, when the direction D2 faces the pressing part 112 of the switching member 110, the direction D1 points into the page. That is to say, the driving component 134, at this moment is abutting the pressing part 112 with the protruding part thereof, and the driving component 136 rather is not. Therefore, the pressing part 112 is rendered in a left-up, right-down state, such that the abutting arm 116 is able to drive the electrical conduction portions 142, 146 to abut together and electrically conduct at this time.

Opposing to this, when the direction D1 faces the pressing part 112 and the direction D2 points out of the page, then the driving component 136 pushes on the pressing part 112, and the driving component 134 rather is not. In this way, the abutting arm 116 swings towards the right side of the figure (namely, the switching member 110 of FIG. 2 is pivoted in a counter clock-wise direction) to move away from the electrical conduction portion 142 (the pressing part 112 forms a left-down, right up state). Therefore, the electrical conduction portion 142 releases the end E2 from the electrical conduction portion 146 through the elastic restoring force of the electrical conduction portion 142. In this way, the switching member 110 is able to achieve an objective of switching on or shutting off the electronic system 20 through the applied force F or by driving of the force coupling assembly 130.

It should also be noted, when the driving components 134, 136 are not pushing on the pressing part 112, the switching member 110 is in a state adapted to receive the applied force F to perform a switching action. In other words, in the switch structure 100 of the present embodiment, there is a working time when the driving components 134, 136 are in a state having no structural relation with the switching member 110, so as to prevent the force coupling assembly 130 from producing an interference between the applied force F. Namely, in one state of usage in the present embodiment, after the control module 150 completes the action of driving the switching member 110 by the force coupling assembly 130, the control module 150 will drive the force coupling assembly 130 such that the direction D1, D2 no longer face the pressing part 112. That is to say, the driving components 134, 136 retreat back into a safe range for the user to safely and smoothly control the switch structure 100 by the proximal control of the applied force F. Namely, the remote control will not force the proximal control to be switched on or shut off. Of course, in another state of usage, the switch structure 100 may be insured to maintain the same state (on or off) and not be affected by the external applied force F by allowing the force coupling assembly 130 to maintain the original position after driving of the switching member 110 is complete, namely the remote control will have enforcement power over the proximal control.

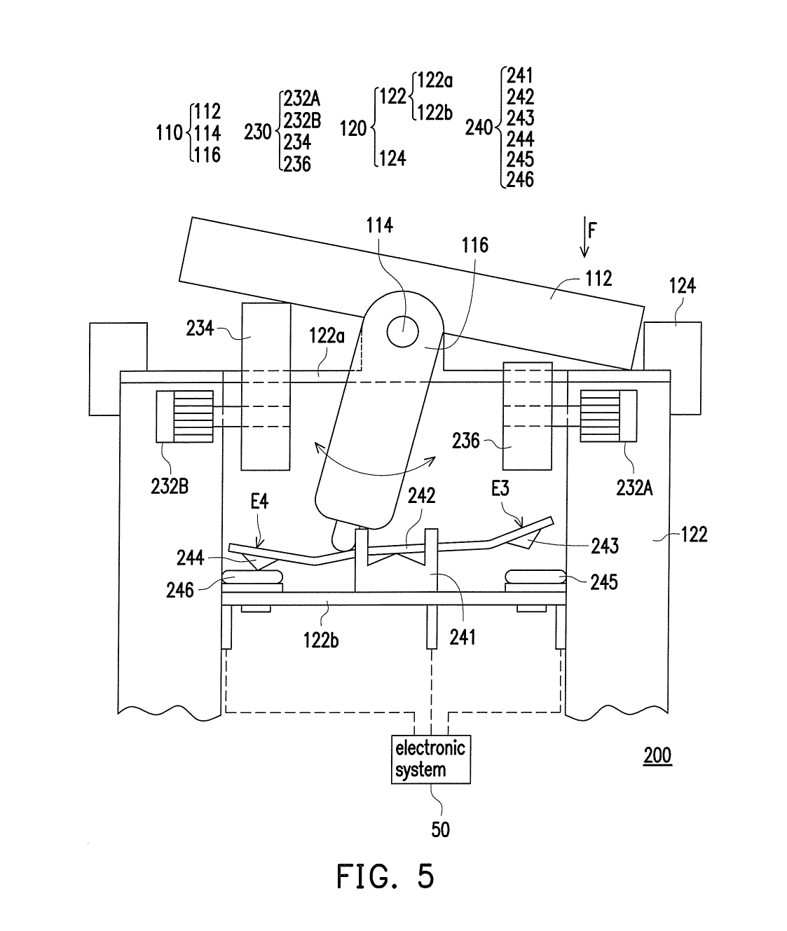

FIG. 5 is a schematic view of a switch structure according to another embodiment of the invention. Referring to FIG. 5, the difference between the previous embodiment lies in, a force coupling assembly 230 of a switch structure 200 includes a pair of power sources 232A, 232B and a pair of driving components 234, 236, wherein the power sources 232A, 232B similarly are electrically connected to the control module (now shown, reference may be made to the control module 150 of the previous embodiment), and the driving components 234, 236 similarly are cam structures, however the difference lies in, the cams are connected on the corresponding motors respectively. Namely, the driving components 234, 236 are each controlled by the power source 232A, 232B and rotate independently of each other. In this way the directions of the protruding parts of the driving components 234, 236 are not required to be bound together. That is to say, the method of operation of the driving components 234, 236 in the present embodiment is changed to be controlled by the control module, and similarly the pressing part 112 of the switching member 110 may be pushed on by the driving components 234, 236 at different working times to achieve a switching effect.

In addition, an electrical conduction module 240 of the present embodiment includes electrical conduction portions 242, 245 and 246, wherein the electrical conduction portion 242, for example, is a double sided spring (reed plate), wherein the center thereof is disposed at the bottom 122b of the frame 122 by the base 241. The base 241 is electrically connected with an electronic system 50, in which the electrical conduction portion 245, 246 are fixed to the bottom 122b respectively and are electrically connected to the electronic system 50. Furthermore, two opposite sides E3, E4 of the electrical conduction portion 242 have contacts 243, 244 respectively, which in a cantilever state when not abutted by the abutting arm 116 correspond to the electrical conduction portions 245, 246 of the switching member 110. As shown in FIG. 5, the contact 243 of the right end E3 is further away from the electrical conduction portion 245 and the contact 244 of the left end E4 is abutted by the abutting arm 116 and abuts and electrically conducts with the electrical conduction portion 246. In this way, the switch structure 200 of the present embodiment, is able to allow the electronic system 50 to achieve different states through the electrical conduction of the base 241 and electrical conduction portion 246 or the electrical conduction of the base 241 and the electrical conduction portion 245 by the different swing locations of the switching member.

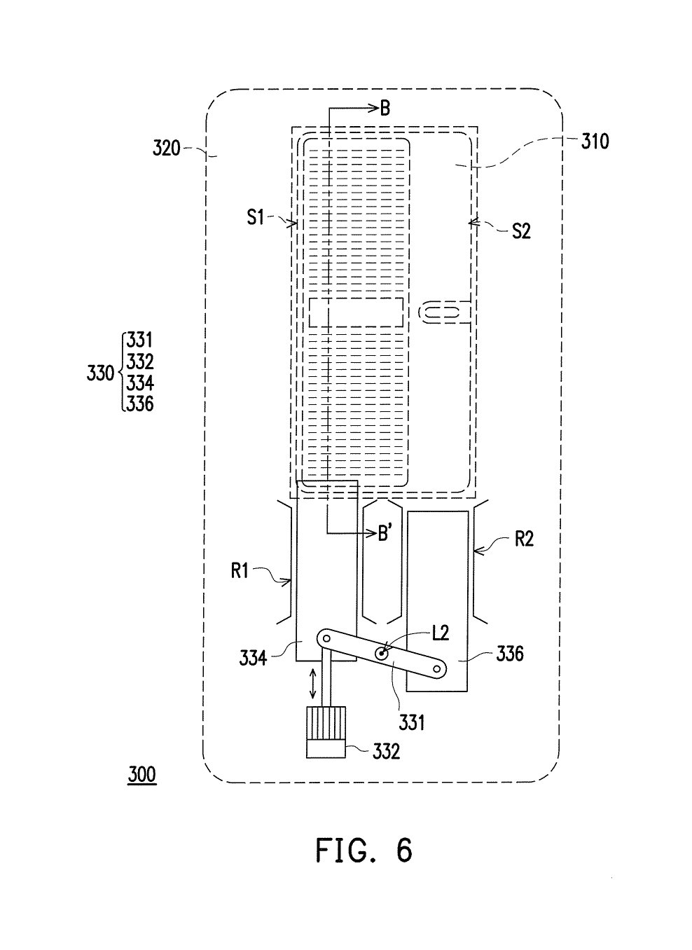

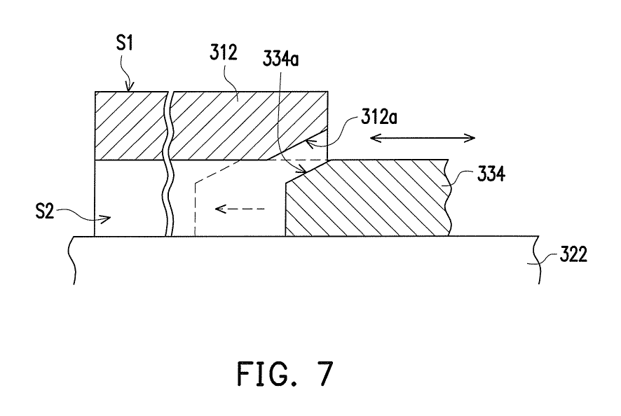

FIG. 6 is a schematic view of a switch structure according to another embodiment of the invention. FIG. 7 is a partial cross-sectional view of the switch structure of FIG. 6 along the line B-B′. Referring to FIG. 6 and FIG. 7, the difference between the previous embodiments lie in, a force coupling assembly 330 of a switch structure 300 of the present embodiment includes a power source (motor) 332, a lever 331 and a pair of driving components 334, 336. Here, a top view of the switch structure 300 is shown and parts of the switching member 310 and the main body 320 are shown in dotted lines, to clearly identify the force coupling assembly 330 disposed in the main body 320.

The driving components 334, 336, for example are sliding blocks, slidably disposed in the rails R1, R2 in the main body 320 respectively, and connected at two opposite ends of the lever 331 respectively. The lever 331 is pivoted at the main body 320; the power source 332 is connected at the lever 331 to drive the lever 331 to pivot about an axis L2. When the lever 331 rotates about the axis L2, the driving components 334, 336 are driven to move under the switching member 310 along the rails R1, R2 at different working times respectively.

More specifically, using the driving component 334 as an example, as shown in FIG. 7, a pressing part 312 of the switching member 310 has a guiding surface 312a located at a lower side of the pressing part 312, and the driving component 334 has an abutting surface 334a located at an upper side of the driving components 334. Thus, the driving component 334 is able to smoothly extend in below the pressing part 312 through an arrangement of the guiding surface 312a and the abutting surface 334a together, and pushes a first side S1 of the pressing part 312 upwards accordingly, namely rendering the pressing part 312 to the first side S1 up and a second side S2 down state. Opposite to this, when the power source 332 drives the lever 331 to rotate in reverse to change to the driving component 336 to extend in below the pressing part 312 and pushes the second side S2 upwards (the guiding surface and the abutting surface are as aforementioned and will not be repeated here), rendering the pressing part 312 to the first side S1 down and the second side S2 up state. In this way, the switching member 310 is able to achieve a switching effect through the power source 332, the lever 331 and the driving components 334, 336.

In the present embodiment, the sliding blocks are disposed next to the switching member 310, and the axis L2 does not pass through the switching member 310. Namely in this way, during a working time, the force coupling assembly 330 has no structural relation with the switching member 310 (as shown in FIG. 6, the lever 331 is rendered in a horizontal state at this time), to facilitate exerting an applied force F (labelled in the aforementioned embodiment), such that the force coupling assembly 330 does not interfere with the applied force F.

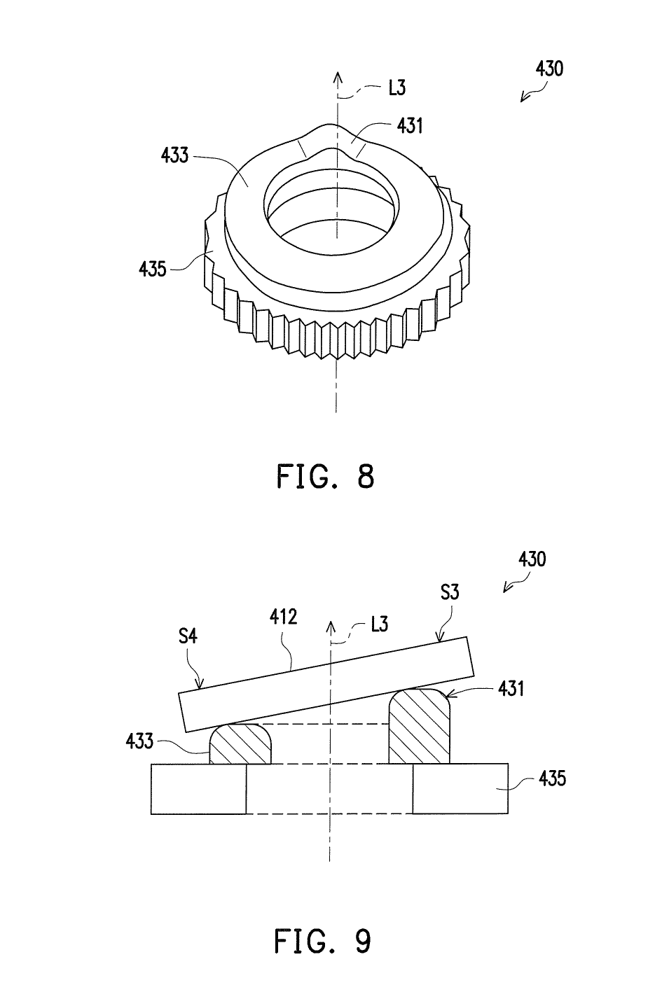

FIG. 8 is a schematic view of partial components of a force coupling assembly according to another embodiment of the invention. FIG. 9 is a schematic view of an operation of the force coupling assembly of FIG. 8 and a switching member. Referring to FIG. 8 and FIG. 9, in the present embodiment, a force coupling assembly 430 includes a driving component 431, a rotating ring 433 and a power source (such as the motor in the aforementioned embodiments, not shown here). The rotating ring 433 rotates about an axis L3, and the axis L3 passes through the pressing part 412 of the switching member. The driving components 431 is a protrusion, disposed on a surface of the rotating ring 433 facing the pressing part 412, such that when the power source drives the rotating ring 433 to rotate, a third side S3 and a fourth side S4 of the pressing part 412 will be located on a moving path of the driving component 431. In this way, the pressing part 412 of the switching member is able to achieve a switching effect through the pushing by the driving component 431 or not. Similar to the aforementioned embodiments, after the driving component 431 is moved away from the pressing part 412, the user is able to exert an applied force F at the pressing part 412 and interference is not produced with the force coupling assembly 430.

In the present embodiment, the rotating ring 433 is disposed on a ring gear 435 having the same axis (L3) to drive the rotating ring 433 to rotate synchronously. However, the structure of the power source driving the rotating ring 433 should not be construed as a limitation to the embodiment, and prior known transmission components which may allow the rotating ring 433 to achieve a rotation effect may be applied to the present embodiment.

In addition, in other embodiments of the invention not shown, the force coupling assembly may include a pair of driving components, namely a pair of protrusions, disposed on the surface of the rotating ring 433 facing the pressing part 412, in which the pair of protrusions and the axis L3 are not on the same diameter of the rotating ring 433. In this way, the rotating ring 433 is able to lower the rotation angle thereof through the disposition of the pair of protrusions. Therefore, wear on the power source may be lowered. In this way, under the premise without using the applied force F, a designer may lower the power output of the power source through disposing a plurality of driving components (protrusions) to achieve a conservation effect.

In summary, in the embodiments of the invention, the switch structure provides a driving mode by receiving an external force, and in addition the switching member may achieve an effect of switching on or shutting off of the electronic system through whether the electrical conduction portions are abutted or not through a remote control of the force coupling assembly. Furthermore, the force coupling assembly may achieve a switching effect by driving the switching member to pivot relative to the main body accordingly through the aforementioned cams of the same shaft, cams of different shafts, the lever driving the sliding blocks and protrusion structures on the rotating ring. The force coupling assembly may provide different effects according to the user's requirement such as conditions of not interfering with the external applied force or using interference to ensure an external applied force does not have an effect. Thus, the ranges of use for the switch structure are increased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A switch structure, used for switching on or shutting off an electronic system, the switch structure comprising:
a main body;
a switching member, pivoted at the main body;
a first electrical conduction portion, disposed in the main body and electrically connected to the electronic system;
a second electrical conduction portion, movably disposed between the switching member and the first electrical conduction portion and electrically connected with the electronic system, in which the second electrical conduction portion is located on a pivoting path of the switching member and the first electrical conduction portion is located on a moving path of the second electrical conduction portion; and
a force coupling assembly, disposed at the main body, in which the switching member is located within a range of motion of the force coupling assembly, the force coupling assembly abuts the switching member at different working times so as to drive the switching member to pivot relative to the main body such that the switching member drives the second electrical conduction portion to lean against the first electrical conduction portion or drives the second electrical conduction portion to release from the first electrical conduction portion, wherein the electronic system is switched on or shut off when the first electrical conduction portion and the second electrical conduction portion abut together.

2. The switch structure as claimed in claim 1, wherein the force coupling assembly comprises:
at least one power source; and
a pair of first driving components, disposed at two opposite sides of a pivoting point of the switching member and the main body respectively, and connected with the power source, in which the power source drives the pair of first driving components to abut the switching member at different working times, to pivot the switching member in opposite directions.

3. The switch structure as claimed in claim 2, wherein during another working time, the pair of first driving components are moved away and do not abut the switching member.

4. The switch structure as claimed in claim 2, wherein the pair of first driving components are cams respectively, located under the switching member and rotate about a first axis, in which each of the cams push upward on the switching member with a protruding part.

5. The switch structure as claimed in claim 4, wherein an orthographic projection of the pair of protruding parts of the pair of cams on a normal plane of the first axis have different directions.

6. The switch structure as claimed in claim 5, wherein an angle between the different directions is 90 degrees.

7. The switch structure as claimed in claim 4, wherein the at least one power source is a motor, in which the pair of cams are assembled on a same shaft of the motor.

8. The switch structure as claimed in claim 4, wherein the at least one power source is a pair of motors, in which the pair of cams are assembled on a pair of shafts of the motors respectively.

9. The switch structure as claimed in claim 2, wherein the force coupling assembly comprises:
a lever, disposed in the main body and located next to the switching member, in which the lever rotates about a second axis, the second axis does not pass through the switching member, the pair of first driving components are sliding blocks respectively disposed at two opposite sides of the lever, the power source is connected with and drives the lever to rotate, such that the pair of sliding blocks are driven to abut the two opposite sides of the switching member respectively.

10. The switch structure as claimed in claim 1, wherein the force coupling assembly, comprises:
a power source; and
at least one second driving component, connected with the power source and passing through two opposite sides of a pivoting point of the switching member and the main body, the power source drives the second driving component to abut different spots of the switching member at different working times, to pivot the switching member in opposite directions.

11. The switch structure as claimed in claim 10, wherein the force coupling assembly comprises:
a rotating ring, connected with the power source, disposed in the main body and located under the switching member, in which the rotating ring rotates about a third axis, the third axis passes through the switching member, the at least one second driving component is a protrusion disposed on a surface of the rotating ring facing the switching member, the power source drives the rotating ring to rotate such that two respective sides of a pivoting point of the switching member and the main body are located on a moving path of the protrusion.

12. The switch structure as claimed in claim 11, wherein the force coupling assembly comprises a pair of protrusions disposed on the surface of the rotating ring facing the switching member respectively, in which the pair of protrusions and the third axis are not on a same diameter of the rotating ring.

13. The switch structure as claimed in claim 1, further comprising:
a control module, electrically connected with the force coupling assembly, in which the control module is adapted to receive wireless signals to drive the force coupling assembly accordingly.
